(19) United States
(12) Patent Application Publication
(10) Pub. No.: US 2021/0389545 A1
(43) Pub. Date: Dec. 16, 2021

(54) LENS WITH LIGHT-CANCELLING PERIPHERY FOR REJECTING LIGHT FROM OUTSIDE A FIELD OF VIEW OF AN IMAGE-CAPTURING DEVICE AND LENS MODULE WITH SUCH LENS

(71) Applicant: HON HAI PRECISION INDUSTRY CO., LTD., New Taipei (TW)

(72) Inventors: CHUN-CHENG KO, New Taipei (TW); PO-CHOU CHEN, Tu-Cheng (TW)

(21) Appl. No.: 16/953,073

(22) Filed: Nov. 19, 2020

(30) Foreign Application Priority Data
Jun. 12, 2020 (CN) 202010538030.3

(51) Int. Cl. G02B 7/02; G02B 13/18

(52) U.S. Cl. CPC G02B 7/021; G02B 13/18

(57) ABSTRACT

A lens effectively rejecting light from outside of a field of view of an image-capturing device can be assembled with other lenses in a lens barrel to form a lens module. The lens includes a central effective optical area and a connection area arranged surrounding the effective optical area. The connection area includes a side surface and adjacent first end surface, the side surface includes a first plane area and an inclined plane area. The inclined plane area extends from an end of the first plane area away from the first end surface toward the axis of the lens. The disclosure also provides the lens module having the above lens.

### FIELD

The subject matter herein generally relates to imaging and lenses.

### BACKGROUND

Electronic devices such as mobile phones, tablet computers, and portable computers generally include image capturing devices, and lens modules as a core component is important for image quality of the image acquisition device. As shown in FIG. 1, a lens module 10 includes a plurality of lenses 12. Light with an incident angle smaller than the field of view of the lens module 10 passes through a transparent aperture of all lenses 12, as shown by path A in FIG. 1, to form an image. Light with an incident angle larger than the field of view of the lens module 10 enters the edge of the lens 12, as shown by path B in FIG. 2. Referring to FIG. 2, adjacent end faces of the lens 12 are perpendicular to each other, and light finally emitted to an image sensor 14 has been reflected, scattered, or absorbed at the edge of the lens 12, which may cause glare or flaring.

### BRIEF DESCRIPTION OF THE DRAWINGS

Implementations of the present technology will now be described, by way of embodiments, with reference to the attached figures.

FIG. 1 is a schematic view of a lens module in prior art.

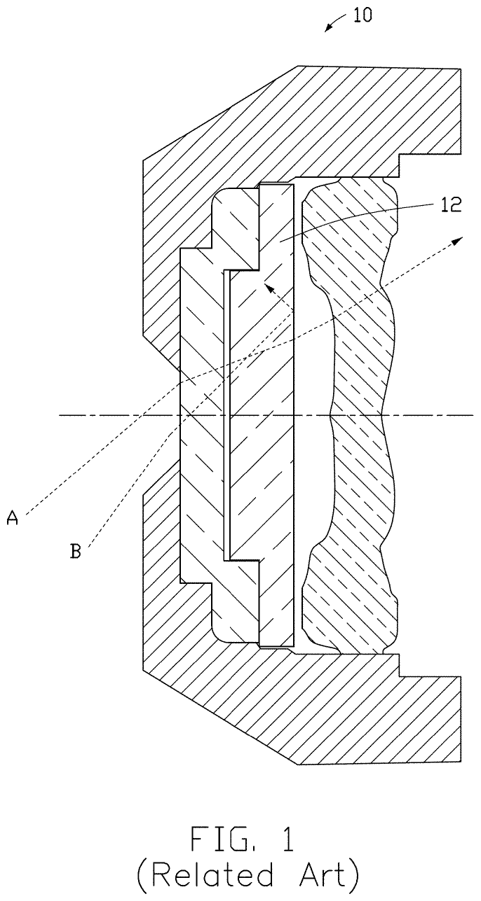

FIG. 2 is a light distribution diagram of the lens module in FIG. 1 with lens barrel omitted.

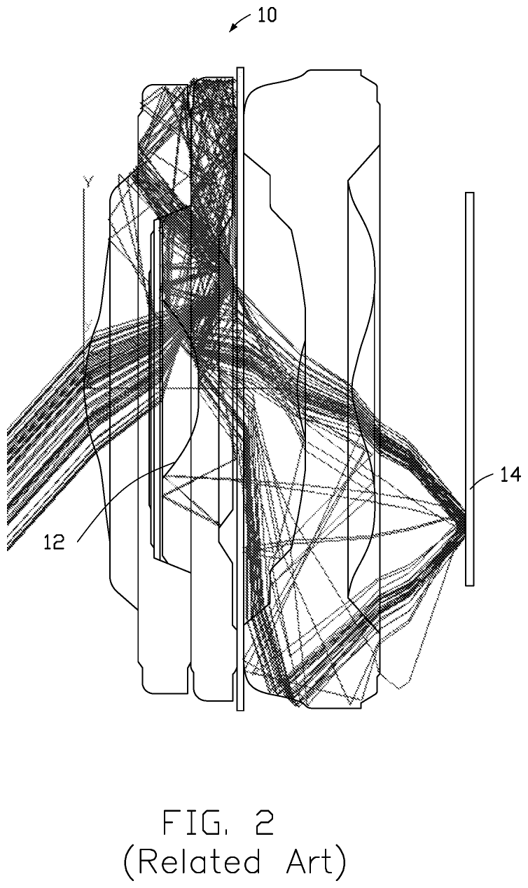

FIG. 3 is a schematic diagram of a lens according to the present disclosure.

FIG. 4 is an enlarged view of circled portion IV in FIG. 3

FIG. 5 is a schematic diagram of a lens module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

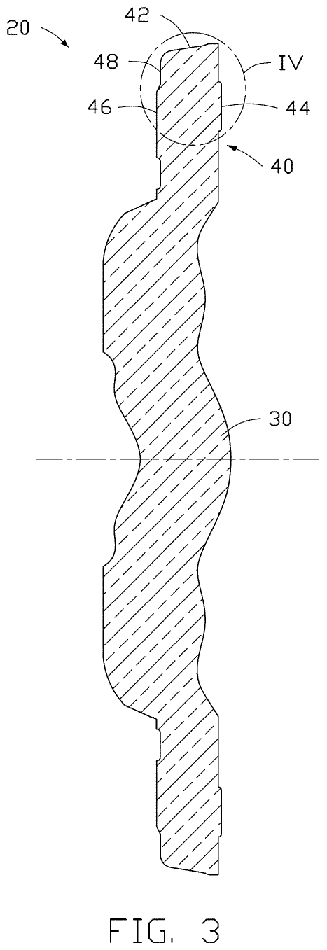

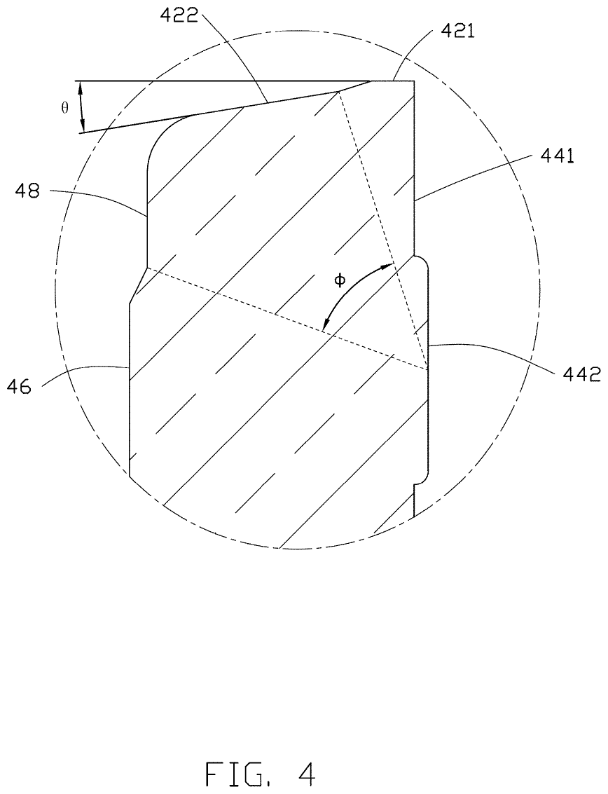

Referring to FIG. 3 and FIG. 4, the disclosure provides a lens 20. The lens 20 includes an effective optical area 30 and a connection area 40. The effective optical area 30 is located at the center of the lens 20 and light penetrates and passes through effective optical area 30 to fall on an image sensor. The connection area 40 is arranged surrounding the effective optical area 30 and has a function in assembly of a lens barrel to form a lens module.

The connection area 40 includes a side surface 42 and a first end surface 44 adjacently connected to the side surface 42. The side surface 42 includes a first plane area 421 and an inclined plane area 422 connected to the first plane area 421. The first plane area 421 is substantially parallel to the central axis of the lens 20. The width of the first plane area 421 along the central axis of the lens 20 is greater than 20 microns, and the first plane area 421 is a polished surface. The inclined plane area 422 extends from an end of the first plane area 421 away from the first end surface 44 toward the axis of the lens 20. A first angle θ is preset between the inclined plane area 422 and the first plane area 421, the preset angle is between 10°-25°.

The first end surface 44 is substantially perpendicular to the central axis of the lens 20. The first end surface 44 includes a second plane area 441 connected to the first plane area 421 and a third plane area 442 connected to the second plane area 441. The third plane area 442 protrudes from the second plane area 441. In another embodiment, the third plane area 442 is in the form of a recess in the second plane area 441.

The connection area 40 further includes a second end surface 46. The second end surface 46 is connected to a side of the side surface 42 away from the first end surface 44. The second end surface 46 and the side surface 42 are connected by an arc surface 48. An end of the arc surface 48 adjacent to the first end surface 44 is connected to the inclined plane area 422, and an end of the arc surface 48 away from the first end surface 44 is located on the second end surface 46.

A second angle Φ between the end of the arc surface 48 away from the inclined plane area 422, the end of the inclined plane area 422 adjacent to the first plane area 421, and the center of the third plane area 442 is a predetermined angle, the predetermined angle is between 35°˜60°. The surface of an end of the arc surface 48 away from the inclined plane area 422 to an end of the inclined plane area 422 adjacent to the first plane area 421 is rough-textured, and scatters the light from one end of the inclined plane area 422 adjacent to the first plane area 421 to the end of the arc surface 48 away from the inclined plane area 422.

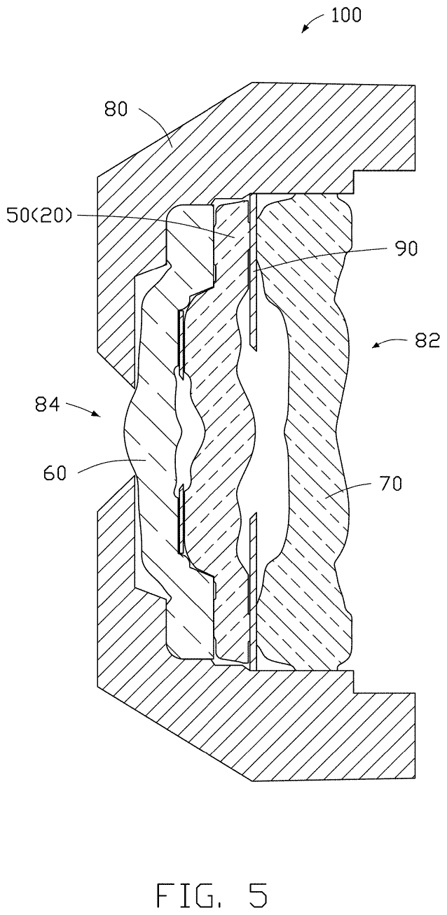

Referring to FIG. 5 and FIG. 4, the disclosure also provides a lens module 100. The lens module 100 includes a first lens 50, a second lens 60, a third lens 70, a lens barrel 80, and an image sensor (not shown). The lens barrel 80 defines a receiving cavity 82 and an opening 84 communicating with the receiving cavity 82. The first lens 50, the second lens 60, and the third lens 70 are fixed in the receiving cavity 82. The first lens 50 is placed between the second lens 60 and the third lens 70, and the second lens 60 is opposite and adjacent to the opening 84. Light entering the opening 84 passes through the second lens 60, the first lens 50, and the third lens 70 to form an image on the image sensor.

The first lens 50 is on the object-side of lens 20, and its structure is the same as that of the lens 20. Since the first lens 50 has the inclined plane area 422, the light with an incident angle greater than the field of view of the opening 84 falls on the inclined plane area 422 and is reflected or refracted by the inclined plane area 422. Compared to the light beams falling approximately parallel to the central axis (“central axis light”), the light entering on the inclined plane area 422 can deviate further from the central axis of the first lens 50, so that after the light reflected or refracted by the inclined plane area 422 is reflected or refracted by the second lens 60, by the first lens 50, and by the third lens 70, there is a greater proportion of central axis light being received by the image sensor, thereby reducing glare. Since the end of the arc surface 48 away from the inclined plane area 422 to the end of the inclined plane area 422 adjacent to the first plane area 421 is rough-textured, light is scattered by the rough texture, so that more light is absorbed by the lens barrel 80 to reduce the amount of stray light inside the cavity 82, thereby reducing glare.

The lens module 100 further includes a plurality of light shielding films 90. The light shielding films 90 are placed between the first lens 50, the second lens 60, and the third lens 70. The light shielding films 90 are arranged surrounding the optical area 30 to further reduce light entering the ineffective optical area 30, thereby further reducing glare. In the embodiment, the protruding third plane area 442 of the first lens 50 bears against the light shielding film 90.

In another embodiment, the lens module 100 includes the first lens 50, the second lens 60, the lens barrel 80, and the image sensor, but does not include the third lens 70. Light entering the second lens 60 passes through the first lens 50 and then enters the image sensor to form an image. In another embodiment, the lens module 100 includes other lenses positioned on one side of the third lens 70 away from the third lens 70, such other lenses being in addition to the first lens 50, the second lens 60, the lens barrel 80, and the image sensor.

The lens 20 and the lens module 100 reduce the amount of the light with an incident angle greater than the field of view of the lens module 100 entering the image sensor opposite to the lens 20 through the inclined plane area 422, thereby reducing glare.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A lens assembling with a lens barrel to form a lens module, the lens comprising:
an effective optical area located at the center of the lens; and
a connection area arranged surrounding the effective optical area, the connection area comprises a side surface and a first end surface adjacently connected to the side surface, the side surface comprises a first plane area and an inclined plane area connected to the first plane area, the inclined plane area extends from an end of the first plane area away from the first end surface toward an imaginary axis of the lens.

2. The lens of claim 1, wherein a width of the first plane area along the imaginary axis of the lens is greater than 20 microns.

3. The lens of claim 1, wherein the first plane area is a smooth surface.

4. The lens of claim 1, wherein a first angle between the inclined plane area and the first plane area is between 10° and 25°.

5. The lens of claim 1, wherein the first end surface comprises a second plane area connected to the first plane area and a third plane area connected to the second plane area and protruded from the second plane area.

6. The lens of claim 5, wherein the connection area further comprises a second end surface, the second end surface is connected to a side of the side surface away from the first end surface, the second end surface and the side surface are connected by an arc surface.

7. The lens of claim 6, wherein a second angle between the end of the arc surface away from the inclined plane area, the end of the inclined plane area adjacent to the first plane area and a center of the third plane area is between 35° and 60°.

8. The lens of claim 1, wherein an end of the arc surface away from the inclined plane area to an end of the inclined plane area adjacent to the first plane area has a non-smooth texture.

9. The lens of claim 1, wherein the first end surface comprises a second plane area connected to the first plane area and a third plane area connected to the second plane area and recessed in the second plane area.

10. A lens module comprising:
a lens barrel defining a receiving cavity and an opening communicating with the receiving cavity;
a first lens received in the receiving cavity and comprising:
an effective optical area located at the center of the lens; and
a connection area arranged surrounding the effective optical area, the connection area comprises a side surface and a first end surface adjacently connected to the side surface, the side surface comprises a first plane area and an inclined plane area connected to the first plane area, the inclined plane area extends from an end of the first plane area away from the first end surface toward an imaginary axis of the lens;
a second lens received in the receiving cavity, and opposite and adjacent to the opening.

11. The lens module of claim 10, further comprising:
a third lens; and
a plurality of light shielding films;
wherein the first lens is placed between the second lens and the third lens, the light shielding films are placed between the first lens and the second lens, the third lens; the light shielding films are arranged surrounding the effective optical area.

12. The lens module of claim 11, wherein the third plane area protruding on the first lens is against the light shielding film.

13. The lens module of claim 10, wherein a width of the first plane area along the imaginary axis of the lens is greater than 20 microns.

14. The lens module of claim 10, wherein the first plane area is a smooth surface.

15. The lens module of claim 10, wherein a first angle between the inclined plane area and the first plane area is between 10° and 25°.

16. The lens module of claim 10, wherein the first end surface comprises a second plane area connected to the first plane area and a third plane area connected to the second plane area and protruded from the second plane area.

17. The lens module of claim 16, wherein the connection area further comprises a second end surface, the second end surface is connected to a side of the side surface away from the first end surface, the second end surface and the side surface are connected by an arc surface.

18. The lens module of claim 17, wherein a second angle between the end of the arc surface away from the inclined plane area, the end of the inclined plane area adjacent to the first plane area and a center of the third plane area is between 35° and 60°.

19. The lens module of claim 10, wherein an end of the arc surface away from the inclined plane area to an end of the inclined plane area adjacent to the first plane area has a non-smooth texture.

20. The lens module of claim 10, wherein the first end surface comprises a second plane area connected to the first plane area and a third plane area connected to the second plane area and recessed in the second plane area.
